(19) United States
(12) Patent Application Publication
(10) Pub. No.: US 2017/0011597 A1
(43) Pub. Date: Jan. 12, 2017

(54) FANTASY SYSTEM AND METHOD BASED ON PERFORMANCE OF FINANCIAL INSTRUMENTS

(71) Applicant: DELANEY GILLILAN, Las Vegas (CA)

(72) Inventor: DELANEY GILLILAN, Las Vegas (CA)

(21) Appl. No.: 14/793,536

(22) Filed: Jul. 7, 2015

(51) Int. Cl. G07F 17/32; G06Q 40/06

(52) U.S. Cl. CPC G07F 17/3286; G07F 17/3269; G07F 17/3211; G07F 17/323; G07F 17/3272; G06Q 40/06

(57) ABSTRACT

System and method for conducting fantasy competitions based on financial markets. Via a dedicated website, participants select financial instruments using a virtual bankroll. A fantasy competition may begin when a particular market (e.g., NYSE) opens and end when the market closes for the day. A winner is the participant achieving the greatest profit from his or her financial instrument selections based on a final value of the selected financial instruments. Competitions may be set up by the operator of the dedicated website or participants themselves.

### FIELD OF THE INVENTION

The embodiments of the present invention relate to a fantasy system based on performance of financial instruments as selected by participants.

### BACKGROUND

Fantasy sports are a burgeoning billion dollar business with well-funded websites (e.g., Draft Kings®) permitting players to play daily fantasy sports tournaments and despite gambling implications national sports leagues (e.g., NFL) are promoting fantasy leagues. Fantasy sports leagues are popular for a myriad of reasons including: (i) building teams; (ii) watching the corresponding games; and (iii) competing with others.

While sports are popular, not everyone follows sports and/or enjoys them. Moreover, sports fans may desire to utilize other real time data to compete with others. For example, real-time stock market data may be suitable to facilitate a fantasy league. The stock market is known to the masses and functions in a manner that may be conducive to facilitating a fantasy system allowing users to compete against one another for fun and/or prizes.

Thus, it would be advantageous to develop a new fantasy or virtual system based on stock market or similar data.

### SUMMARY

The embodiments of the present invention are directed to a system comprising: at least one website server configured to communicate with one or more user terminals; an application running on said website server or a computer in communication therewith, said application configured to: (i) allow multiple remote users to participate in a competition whereby each user selects multiple financial instruments; (ii) track performance of said multiple financial instruments and (iii) determine a winner of said competition based on comparing an aggregate performance of said financial instruments for each user after a pre-established time period has passed. A substantially real-time feed of financial data in communication with said at least one website server may be used to provide current standings.

A method embodiment of the present invention comprises configuring at least one website server to communicate with one or more user terminals; running an application on said website server or a computer in communication therewith, said application for: (i) allowing multiple remote users to participate in a competition whereby each user selects multiple financial instruments; (ii) tracking performance of said multiple financial instruments and (iii) determining a winner of said competition based on comparing an aggregate performance of said financial instruments for each user after a pre-established time period has passed.

In broad terms, the embodiments of the present invention involve users selecting financial instruments (e.g., stocks, mutual funds, etc.) which the users anticipate will increase in value during a given time period (e.g., 1 market day) as tracked by a financial exchange (e.g., NYSE). The user selecting the financial instruments which have the greatest increase in value, wins the competition.

Many different structures for the competitions may be utilized as detailed in more detail below. For example, a competition may only allow certain pre-designated stocks to be selected while another competition may allow users to select any tracked stock.

Other variations, embodiments and features of the present invention will become evident from the following detailed description, drawings and claims.

### BRIEF DESCRIPTION OF THE DRAWINGS

FIG. 1 illustrates a block diagram of components of a computer for conducting a competition according to the embodiments of the present invention

FIG. 2 illustrates a block diagram of a network for conducting a competition according to the embodiments of the present invention;

FIG. 3 illustrates a flow chart detailing one methodology for conducting a competition according to the embodiments of the present invention;

FIGS. 4A-4E illustrate exemplary screen shots according to the embodiments of the present invention;

FIG. 5 illustrates a flow diagram of a method of generating a team according to the embodiments of the present invention;

FIG. 6 illustrates a flow diagram of a method of creating a team according to the embodiments of the present invention; and

FIG. 7 illustrates a flow diagram of a competition according to the embodiments of the present invention

### DETAILED DESCRIPTION

For the purposes of promoting an understanding of the principles in accordance with the embodiments of the present invention, reference will now be made to the embodiments illustrated in the drawings and specific language will be used to describe the same. It will nevertheless be understood that no limitation of the scope of the invention is thereby intended. Any alterations and further modifications of the inventive feature illustrated herein, and any additional applications of the principles of the invention as illustrated herein, which would normally occur to one skilled in the relevant art and having possession of this disclosure, are to be considered within the scope of the invention claimed.

Those skilled in the art will recognize that the embodiments of the present invention involve both hardware and software elements which portions are described below in such detail required to construct and operate a method and system according to the embodiments of the present invention.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.), or an embodiment combining software and hardware. Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), and optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied thereon, for example, in baseband or as part of a carrier wave. Such a propagated signal may take any variety of forms, including, but not limited to, electromagnetic, optical, or any suitable combination thereof. A computer readable signal medium may be any computer readable medium that is not a computer readable storage medium and that can communicate, propagate, or transport a program for use by or in conjunction with an instruction execution system, apparatus, or device.

Program code embodied on a computer readable medium may be transmitted using any appropriate medium, including but not limited to wireless, wireline, optical fiber cable, RF and the like, or any suitable combination of the foregoing.

Computer program code for carrying out operations for aspects of the present invention may be written in any combination of one or more programming languages, including an object oriented programming language such as Java, Smalltalk, C++ or the like or conventional procedural programming languages, such as the “C” programming language, AJAX, PHP, HTML, XHTML, Ruby, CSS or similar programming languages. The programming code may be configured in an application, an operating system, as part of a system firmware, or any suitable combination thereof. The programming code may execute entirely on the user's computer, partly on the user's computer, as a standalone software package, partly on the user's computer and partly on a remote computer or entirely on a remote computer or server as in a client/server relationship sometimes known as cloud computing. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram.

The computer program instructions may also be loaded onto a computer, other programmable data processing apparatus, or other devices to cause a series of operational steps to be performed on the computer, other programmable apparatus or other devices to produce a computer-implemented process such that the instructions which execute on the computer or other programmable apparatus provide processes for implementing the functions/acts specified in the flowchart and/or block diagrams. As used herein, a computer should be understood to be any one of a general purpose computer, as for example a personal computer or a laptop computer, a client computer configured for interaction with a server, a special purpose computer such as a server, or a smart phone, soft phone, tablet computer, personal digital assistant or any other machine adapted for executing programmable instructions in accordance with the description thereof set forth above.

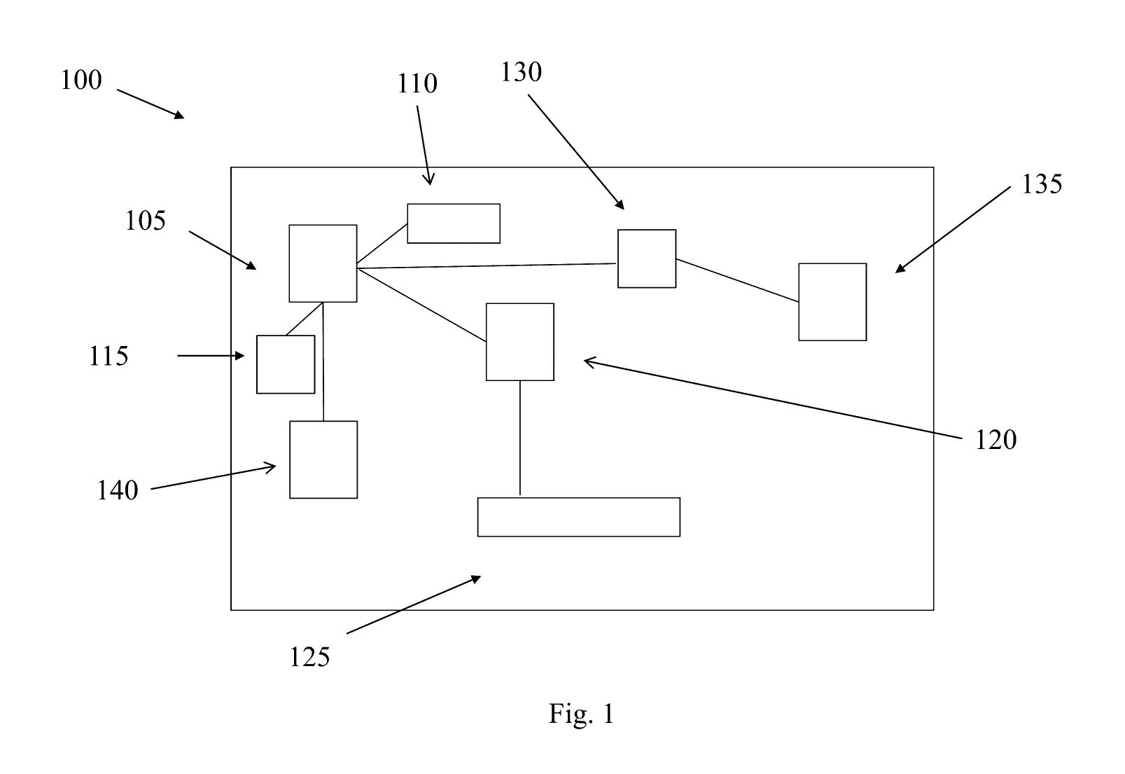

A block diagram of a computer 100 is shown in FIG. 1. The exemplary computer 100 may include a central processing unit (CPU) also deemed a processor 105 which controls the computer 100 based on instructions stored in program read-only memory (ROM) 110. Program ROM 110 stores executable instructions related to the operation of the computer 100 and which are generally permanent. CPU 105 may be connected to a video controller 120 which provides output to one or more video displays 125. Similarly, an audio controller 130 provides audio output as dictated by the CPU 105 through speakers 135. The aforementioned components, and others, may be attached to a circuit board forming a motherboard. In another embodiment, the computer 100 may be linked to a central or remote server which allows players to participate in a competition. In such an embodiment, one or more processors integrated into the central server control the computer 100 based on instructions stored in program ROM 110. A user interface 140 may respond to buttons or display incorporating touch screen technology or any other devices providing means for users to communicate with, and instruct, the computer 100.

Those skilled in the art will recognize that the configuration and features of the electronic computer 100 disclosed herein are exemplary and may be altered in any number of ways without impacting the embodiments of the present invention.

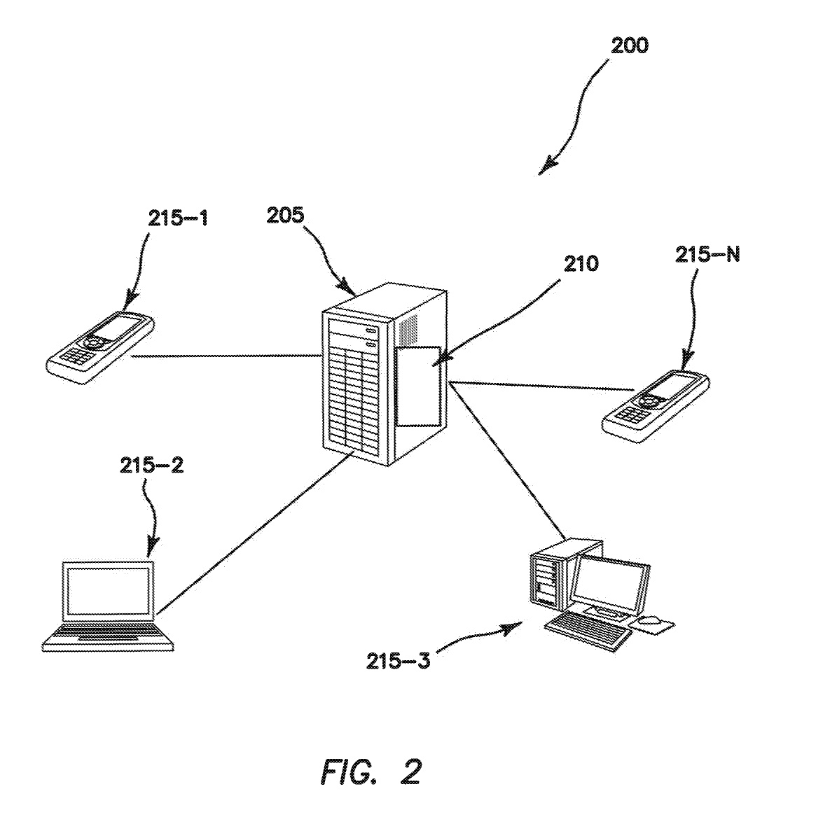

FIG. 2 shows a block diagram of a wireless/wired network system 200 which may be used to facilitate competitions according to the embodiments of the present invention. The network system 200 comprises a server 205, including one or more processors 210 running fantasy competition software, and remote devices 215-1 through 215-N (e.g., smart phones) configured to access said server 205 facilitating fantasy competition via the remote devices 215-1 through 215-N. In another embodiment, the fantasy competition according to the embodiments of the present invention may be in the form of a software application (“App”) downloadable onto smart phones, tablets or computers and playable via processing power and a user interface associated therewith.

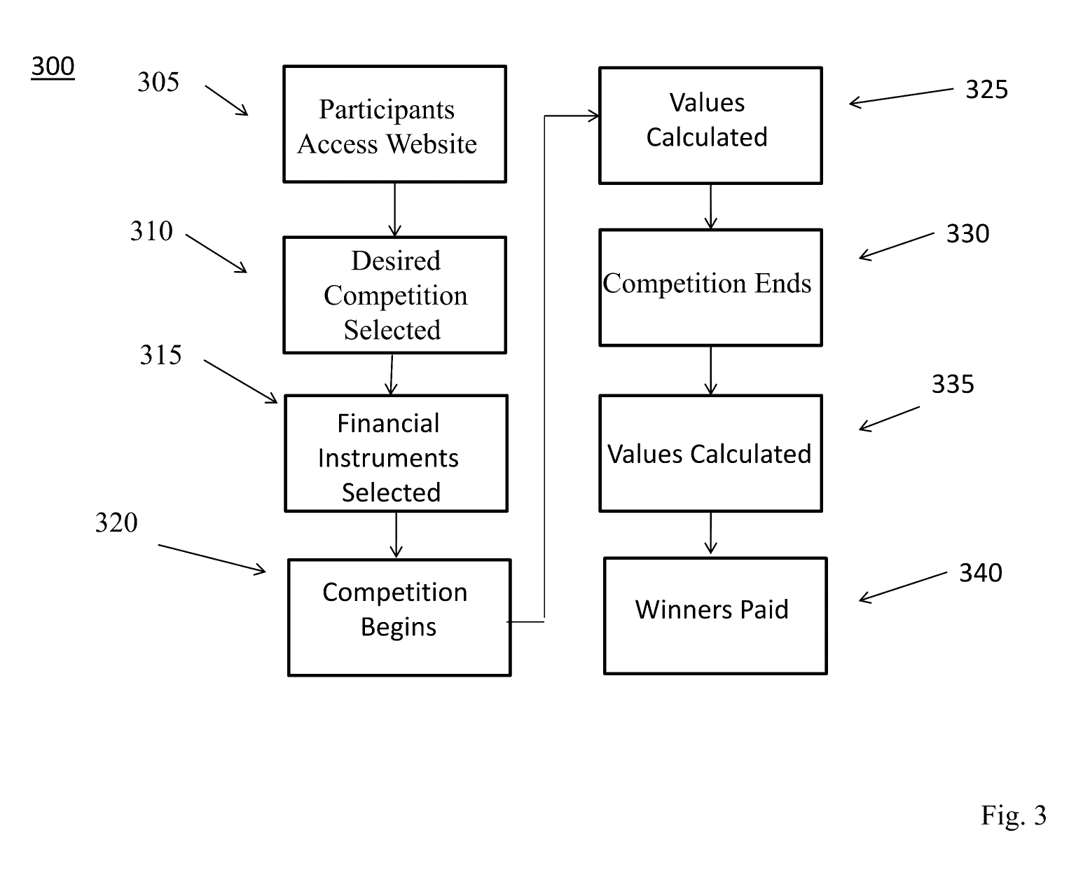

FIG. 3 shows a flow chart 300 detailing one methodology for conducting a fantasy competition according to the embodiments of the present invention. At 305, participants/competitors access a dedicated website or similar location associated with a fantasy competition based on financial instruments. For example, a dedicated website may have an exemplary URL of www.fantasystockmarket.com. The website may be access through server 205 or a separate server in communication therewith. At 310, participants are able to select a fantasy competition from a plurality of fantasy competitions. The plurality of fantasy competitions may be based on various factors including different financial instruments such as stocks, mutual funds, bonds, commodities, etc., entry fees, time period, etc. The plurality of fantasy competitions may also be for-fun competitions or require cash entry fees which are used to generate prize pools. At 315, participants select financial instruments from within the selected fantasy competition forming a portfolio. The number of selected financial instruments is dictated by the operator. For example, there may be 30 stocks to choose from and each participant must select 10 using a given bankroll. Alternatively, the participant may be able to select any number of financial instruments using the given bankroll. At 320, the selected fantasy competition begins based on pre-established start time such as stock market opening. At 325, responsive to the passage of a pre-established amount of time (e.g., end of stock market day) associated with the fantasy competition, the competition ends and, at 330, values of each participant's selected financial instruments (i.e., portfolio) are calculated. The value being how much money the participant would have profited, or lost, based on the participant's selections of financial instruments. At 335, the participant having profited the most (or if all participants post losses, the participant with the least amount of losses) among all participants is deemed the winner of the competition. At 340, if entry fees were paid, the winning participant is provided the winning prize which may be a certain percentage of the total amount of entry fees or a fixed amount. If a competition is to last more than one day, participants may be able to modify their financial instrument selections.

In one embodiment, the website provides direct access to historical data concerning financial markets that can be used to strategize by the participants. For example, a stock's previous stock value or news reports may be displayed for use and research in determining how to create the most successful virtual/fantasy stock portfolio. In one embodiment, the website allows for participants to view the historical track record of other participants. Alternatively, such historical data may not be displayed for other participants. In one embodiment, the website is the sole source of final results and payouts, if any, of resulting competitions or cancellations thereof. When possible, the website provides all participants with the exact same density of historical data as to provide a fair and balanced playing field.

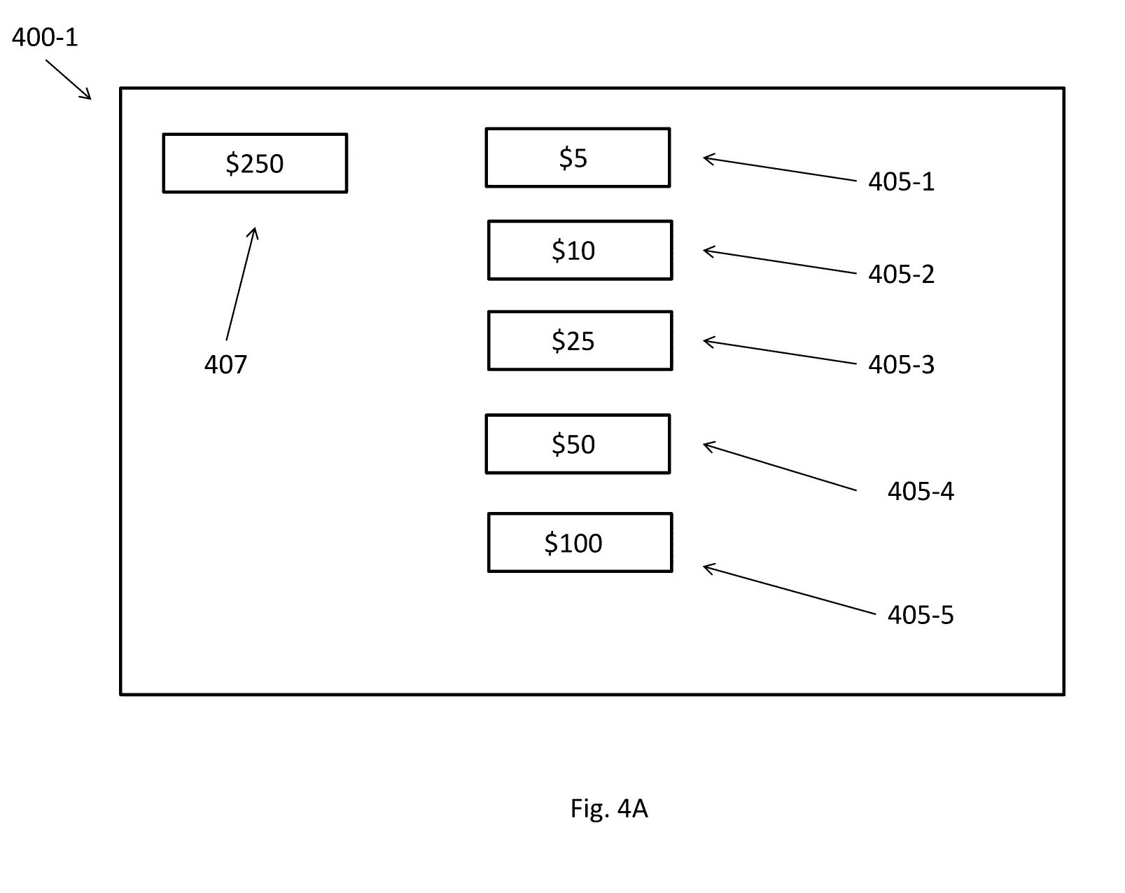

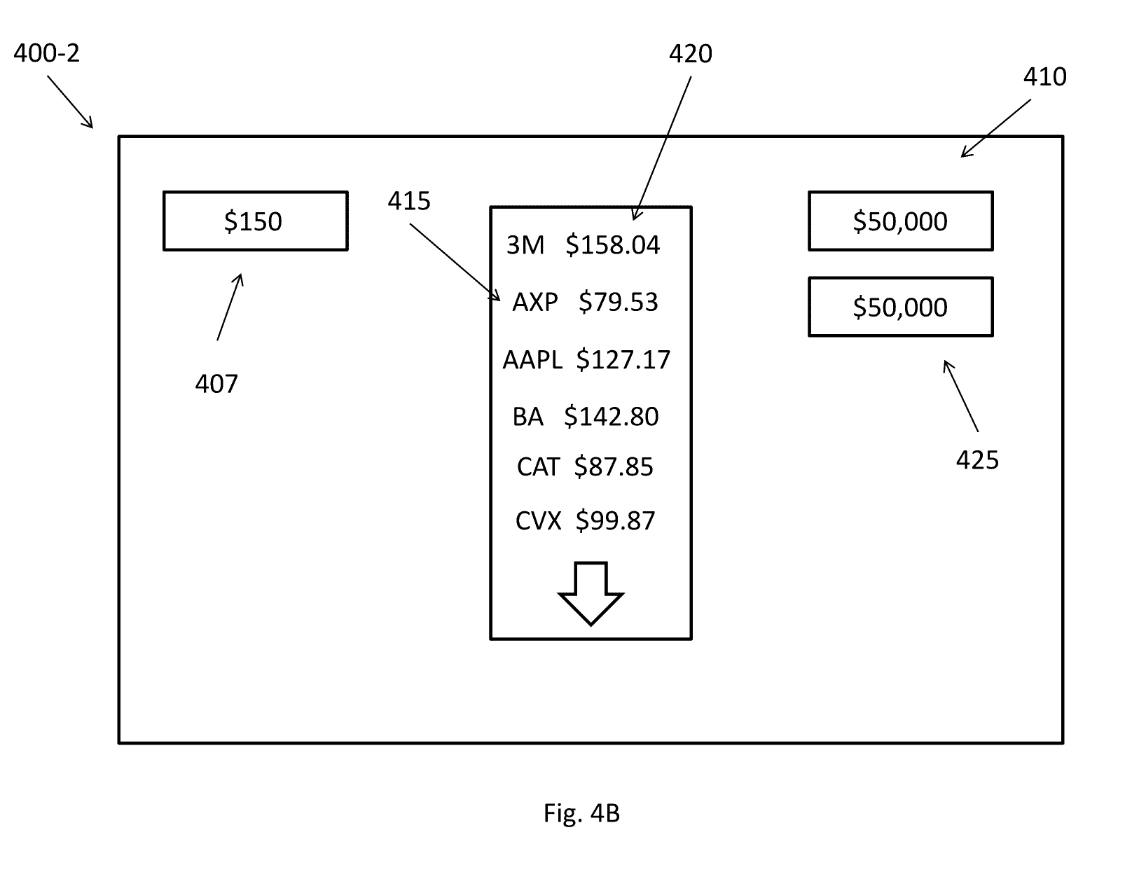

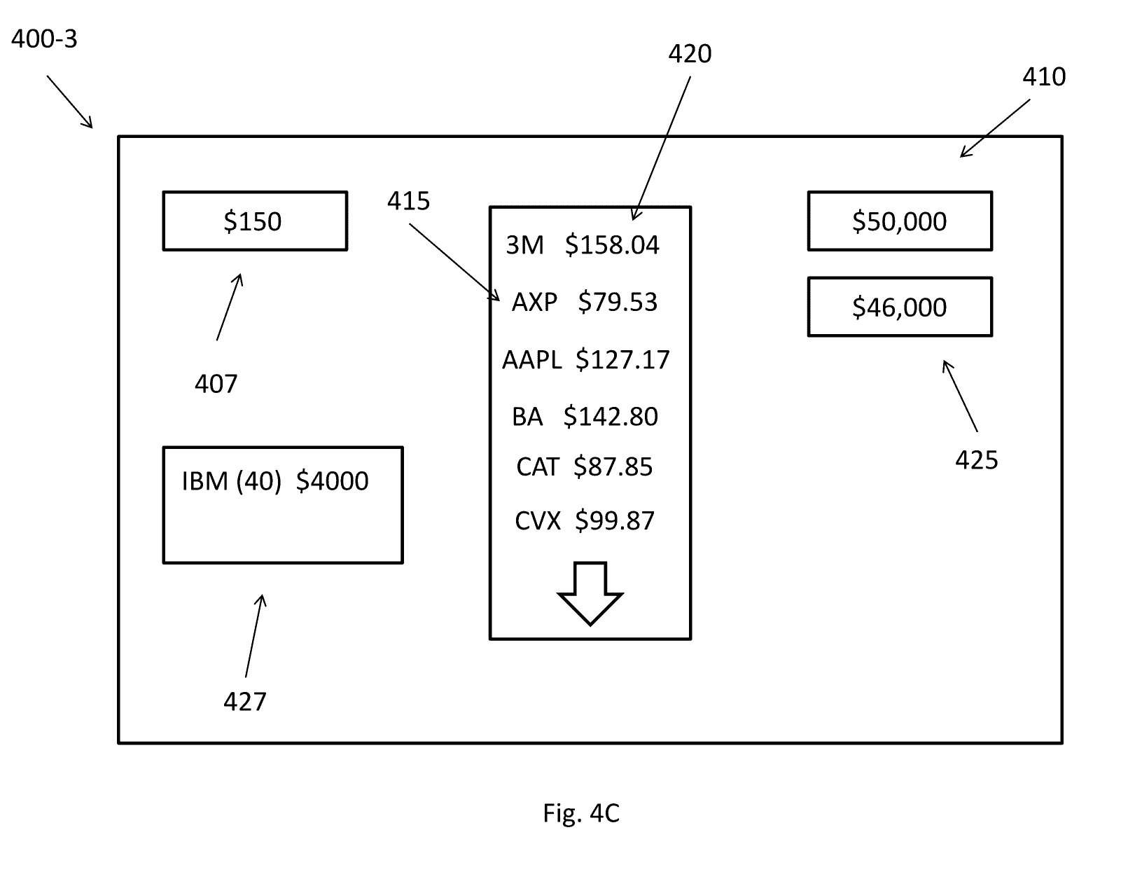

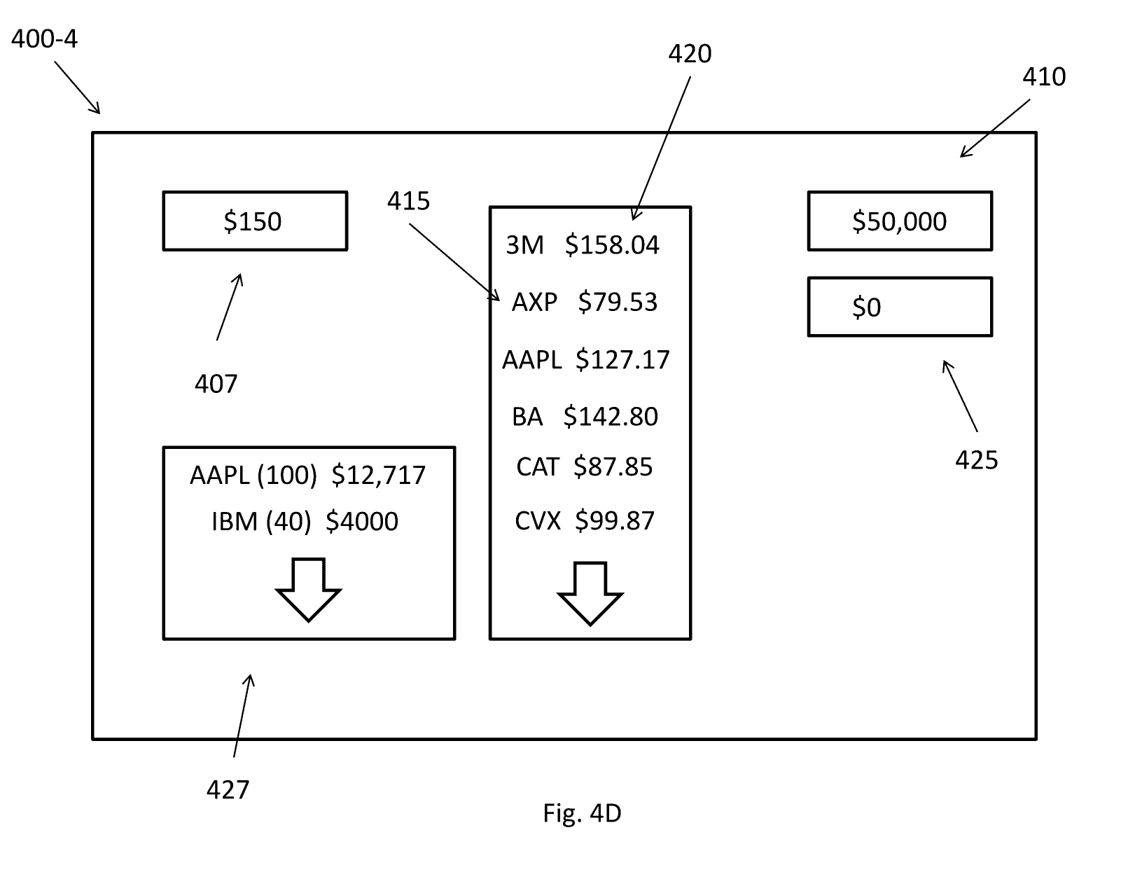

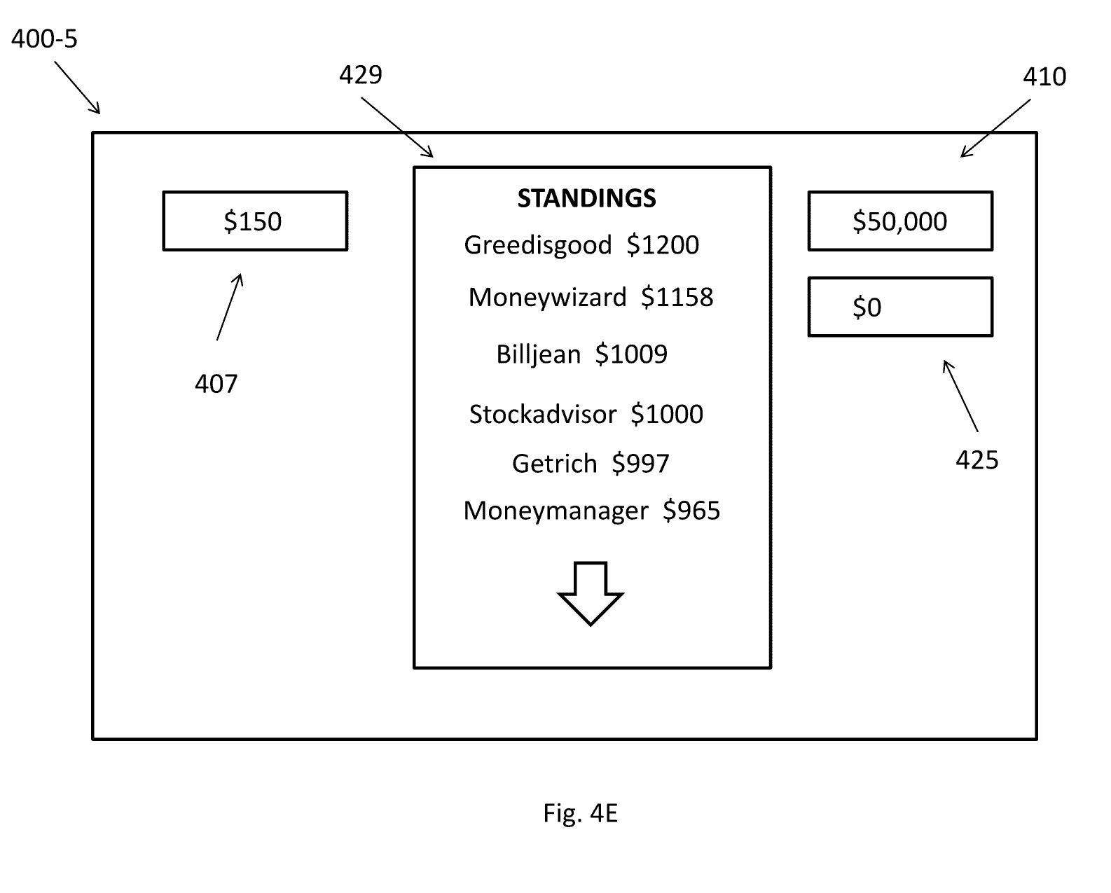

FIGS. 4A-4E show exemplary screen shots 400-1 through 400-5 according to the embodiments of the present invention. The series of screen shots 400-1 through 400-5 is based on stocks but those skilled in the art will understand that any financial instruments may be used. Moreover, the structure of the fantasy competition may be altered without departing from the spirit and scope of the present invention. FIG. 4A shows a home page 400-1 depicting multiple competitions based on entry fees 405-1 through 405-5 ranging from $5 to $100. The range and limits of entry fees are dictated by the operator. The participant's account balance 407 is also shown. Once the participant selects one of the entry fees 405-1 through 405-5 (405-5 in this instance), the participant's account (or other means of payment) is used to pay the entry fee and the participant is moved to a stock selection screen 400-2 shown in FIG. 4B. The stock selection screen 400-2 depicts a competition bankroll 410, available stocks 415, current price 420 and bankroll calculator 425. In one embodiment, there are 30 available stocks where the 30 stocks are those that make up the Dow Jones Industrial Average. FIG. 4C depicts a screen 400-3 after the participant has selected 40 shares of IBM at $100 each shown in window 427 such that the bankroll calculator 425 shows $46,000 ($50,000-$4000). This process continues until, as shown in screen 400-4 of FIG. 4D, the participant has exhausted the $50,000 bankroll 410. FIG. 4E shows screen 400-5 depicting each participant and providing access to each participant's selected stocks. Screen 400-5 is not accessible until the fantasy competition begins such that participants are not able to take advantage of information from the selections of other participants. In one embodiment, the fantasy competition starts when the New York Stock exchange opens and concludes when it closes the same day. Once the fantasy competition begins, screen 400-5 depicts competition standings 429 based on each participant's profit and loss in substantially real-time. As shown, the participant having screen name “GreedisGood” leads the competition having a real-time profit of $1200 followed by others. Screen 400-5 also shows the total pool 430 to be awarded the winner or winners of the competition. The total pool 430 is the total number of entry fees minus the operator's fee to operate the website. That is, the fantasy competition may pay the entire total pool 430 to the single winner or may pay a certain number of top finishers based on the number of participants. In one example, 10% of the total number of participants receives a portion of the total pool. In this example, if there 100 participants, the top 10 finishers receive some portion of the total pool based on a pre-established calculation. Normally, the winner receives 50% of the total pool while the other 9 participants receive smaller percentages indicative of their finishing position. However, any payout percentages are conceivable.

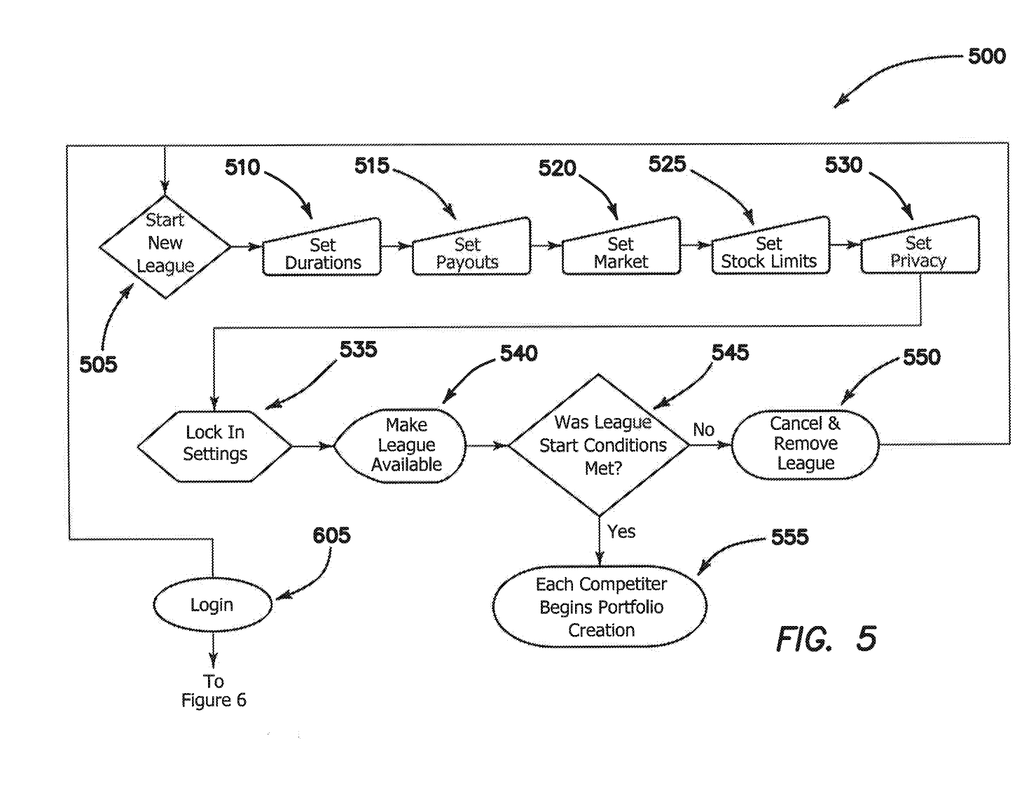

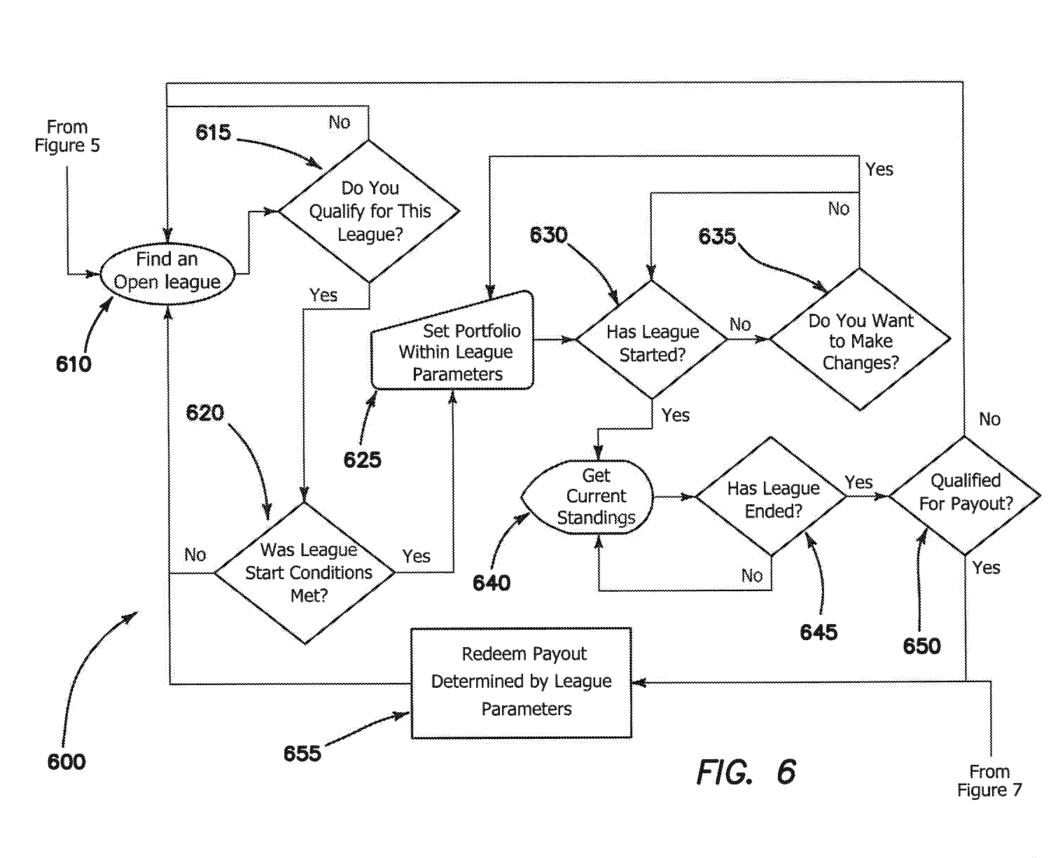

FIG. 5 shows a flow diagram 500 of a method of generating a team according to the embodiments of the present invention. In this instance, at 505, a participant or operator may form or start a new competition/league. At 510, the competition duration is established. At 515, the competition payouts are established. At 520, the competition market is established. At 525, the competition stock limits/bankroll is established. At 530, the competition privacy features are established. At 535, the competition conditions are locked in. At 540, the competition is made available to other participants via the dedicated website. At 545, it is determined if the competition start conditions were met. If not, at 550, the competition is canceled. If so, at 555, the participants begin creating portfolios.

FIG. 6 shows a flow diagram 600 of a method of creating a team according to the embodiments of the present invention. At 605, competitors log on and, at 610, participants look for an open league or competition. At 615, it is determined if the participant qualifies for the competition. If not, the chart 600 loops back to 610. If the participant qualifies, at 620, it is determined if the competition start conditions are met. If the competition start conditions are not met, the chart 600 loops back to 610. If the competition start conditions are met, at 625, the participant's portfolio is set. At 630, it is determined if the league has started. If not, at 635, changes may be made. If, at 630, it is determined that the league has started, at 640, current standings are made available. Current standings are based on substantially real-time information of the ever-fluctuating value of the financial instruments. At 645, it is determined if the league has ended. If the league has ended, at 650, it is determined if the participant is entitled to a payout as a winner. If the participant is entitled to a payout, at 655, the payout is made via an account held by the participant.

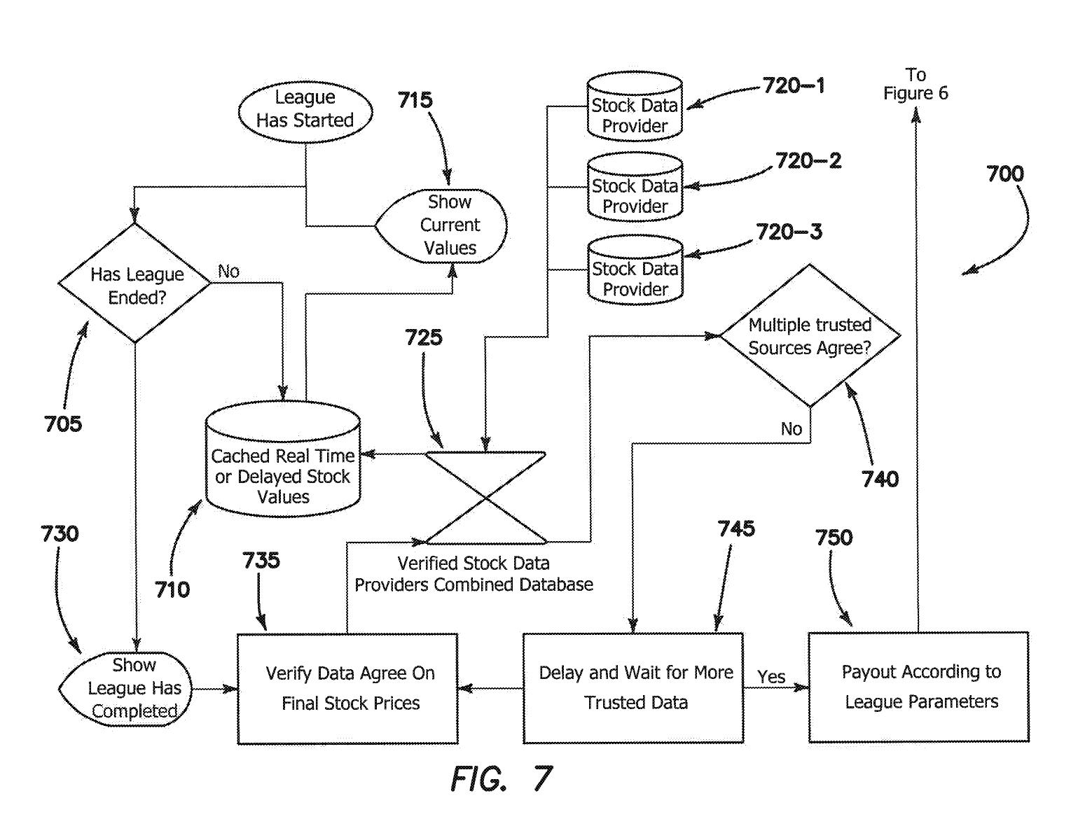

FIG. 7 shows a flow diagram 700 of a competition according to the embodiments of the present invention. At 705, once league has started, it is determined if the league or competition has ended. If the competition has not ended, the values of the stocks or other financial instruments are cached in memory and at 710 the values are displayed at 715. The stock values are provided by one or more stock data providers 720-1 through 720-3 which are aggregated in a single database 725 in communication with the cache. At 730, the competition has ended causing final stock prices to be verified at 735. At 740, the system receives additional verified data and, at 745, pauses to receive trusted data. At 750, after one or more verifications of the stock process, winning participants are paid.

Those skilled in the art will recognize that asynchronous communication with mobile devices and the like shall facilitate the system and method disclosed herein. That is, while the system may provide live standings based on substantially real-time values of the financial instruments, only the final values need to be used to determine a winner or winners of a subject competition.

In the event of a tie, tie breaking rules are used to distribute winnings. Examples of such tie breaking rules include sharing winnings, declaring the most diversified portfolio the winner, declaring stock shares with the highest delta in prices the winner, etc.

In one embodiment, participants may create leagues or tournaments for public play or set them up for invitation only. Once the criteria (number of participants, entry fees, virtual bankroll, area of market covered, duration, etc.) are set, that league's rules remain for the duration of the competition. Multiple competition formats may be used including head-to-head, round robin and bracket tournaments, league v. league. Before the start of a competition, a league or competition may be canceled. Once a competition or league starts, it is not complete until the results of the competition have been determined by the rules and settings established prior to the start of play.

The use of real world financial market data allows for the same level of skill as used by fund managers, without the minimum investment limits, based on the same information available from historical trends. This leads to a far more grounded playing field than competitions using sports, for example, as the metrics. The embodiments of present invention allow for the foundation of securities without the direct regulations mandated by such real world transactions

Although the invention has been described in detail with reference to several embodiments, additional variations and modifications exist within the scope and spirit of the invention as described and defined in the following claims.

I claim:

1. A fantasy competition system comprising:
at least one processor configured to run a fantasy competition, said processor in communication with one or more computer devices, each of said one or more computer devices including a display, user interface, and memory in communication with said at least one processor; and
wherein said processor is configured to conduct said fantasy competition by: (i) receiving input selections of financial instruments by multiple competitors; (ii) utilizing a performance of each selected financial instrument to calculate a profit or loss associated with the financial instrument selections of each competitor in said financial competition and (iii) determining one or more winners of said fantasy competition based on the competitor holding the financial instruments having the most profit or least losses.

2. The fantasy competition system of claim 1 wherein said at least one processor is configured to conduct said fantasy competition over a pre-established time period consisting of a market day.

3. The fantasy competition system of claim 1 further comprising a substantially real-time feed of current financial instrument values.

4. The fantasy competition system of claim 1 wherein said at least one processor is configured to display competition standings.

5. The fantasy competition system of claim 1 wherein said at least one processor is configured to provide access to historical data associated with said financial instrument.

6. A fantasy competition system comprising:
at least one processor configured to run a fantasy competition, said processor in communication with one or more computer devices, each of said one or more computer devices including a display, user interface, and memory in communication with said at least one processor; and
wherein said processor is configured to conduct said fantasy competition by: (i) receiving fantasy competition parameters by one or more competitors; (ii) establishing a fantasy competition associated with said fantasy competition parameters; (iii) receiving input selections of financial instruments by multiple competitors; (iv) utilizing a performance of each selected financial instrument to calculate a profit or loss associated with the financial instrument selections of each competitor in said financial competition and (v) determining one or more winners of said fantasy competition based on the competitor holding the financial instruments having the most profit or least losses.

7. The fantasy competition system of claim 6 wherein said at least one processor is configured to conduct said fantasy competition over a pre-established time period consisting of a market day.

8. The fantasy competition system of claim 6 further comprising a substantially real-time feed of current financial instrument values.

9. The fantasy competition system of claim 6 wherein said at least one processor is configured to display competition standings.

10. The fantasy competition system of claim 6 wherein said at least one processor is configured to provide access to historical data associated with said financial instrument.

11. A method of conducting a fantasy competition comprising:
utilizing at least one processor in communication with multiple computer devices each having a display, interface and memory for:
(i) receiving input selections of financial instruments by multiple competitors;
(ii) utilizing a performance of each selected financial instrument to calculate a profit or loss associated with the financial instrument selections of each competitor in said financial competition; and
(iii) determining one or more winners of said fantasy competition based on the competitor holding the financial instruments having the most profit or least losses.

12. The method of claim 11 further comprising utilizing said at least one processor in communication with multiple computer devices each having a display, interface and memory for:
prior to step (i), receiving fantasy competition parameters by one or more competitors.

13. The method of claim 11 further comprising utilizing said at least one processor in communication with multiple computer devices each having a display, interface and memory for:
conducting said fantasy competition over a pre-established time period consisting of at least a market day.

14. The method of claim 11 further comprising receiving a substantially real-time feed of current financial instrument values.

15. The method of claim 11 further comprising utilizing said at least one processor in communication with multiple computer devices each having a display, interface and memory for:
displaying competition standings.

16. The method of claim 11 further comprising utilizing said at least one processor in communication with multiple computer devices each having a display, interface and memory for:
providing access to historical data associated with said financial instrument.

17. The method of claim 11 further comprising utilizing said at least one processor in communication with multiple computer devices each having a display, interface and memory for:
accepting entry fees from each competitor and providing payouts for one or more winning competitors.
